(19) United States
(12) Patent Application Publication
(10) Pub. No.: US 2007/0164529 A1
(43) Pub. Date: Jul. 19, 2007

(54) Walker assembled and detached easily and rapidly

(76) Inventor: Tim Lin, Taichung City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/328,831

(22) Filed: Jan. 10, 2006

(51) Int. Cl. B62M 1/00

(52) U.S. Cl. 280/87.021

(57) ABSTRACT

A Walker includes a front fork, a handlebar mounted on an upper end of the front fork, a front wheel mounted on a lower end of the front fork, a support unit mounted on the upper end of the front fork in a downwardly inclined manner, a rear wheel mounted on a lower portion of the support unit, and a seat unit mounted on an upper portion of the support unit. Thus, the Walker is assembled and detached easily and rapidly to facilitate a user mounting and dismantling the Walker. In addition, all of the parts of the Walker are detachable before assembly to reduce the volume largely, thereby greatly decreasing costs of packaging, storage and transportation of the Walker.

### BACKGROUND OF THE INVENTION

1. Field of the Invention

The present invention relates to a Walker and, more particularly, to a Walker for a child.

2. Description of the Related Art

A conventional Walker provides an aid function to a child. However, the conventional Walker has a fixed construction and cannot be assembled and disassembled by the user. In addition, the conventional Walker has a larger volume and occupies a larger space of storage. Further, the conventional Walker has a larger volume, thereby increasing costs of packaging, storage and transportation of the Walker.

### SUMMARY OF THE INVENTION

In accordance with the present invention, there is provided a Walker, comprising a front fork, a handlebar mounted on an upper end of the front fork, a front wheel mounted on a lower end of the front fork, a support unit mounted on the upper end of the front fork in a downwardly inclined manner, a rear wheel mounted on a lower portion of the support unit, and a seat unit mounted on an upper portion of the support unit.

The primary objective of the present invention is to provide a Walker that is assembled and detached easily and rapidly to facilitate a user mounting and dismantling the Walker.

Another objective of the present invention is to provide a Walker, wherein all of the parts of the Walker are detachable before assembly to reduce the volume largely, thereby decreasing costs of packaging, storage and transportation of the Walker.

A further objective of the present invention is to provide a Walker, wherein the walker has a simplified construction, thereby greatly decreasing costs of fabrication.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a walker in accordance with the preferred embodiment of the present invention.

FIG. 2 is an exploded perspective view of the walker as shown in FIG. 1.

FIG. 3 is a partially exploded perspective view of the walker as shown in FIG. 1.

FIG. 4 is a side plan operational view of the walker as shown in FIG. 1 in use.

### DETAILED DESCRIPTION OF THE INVENTION

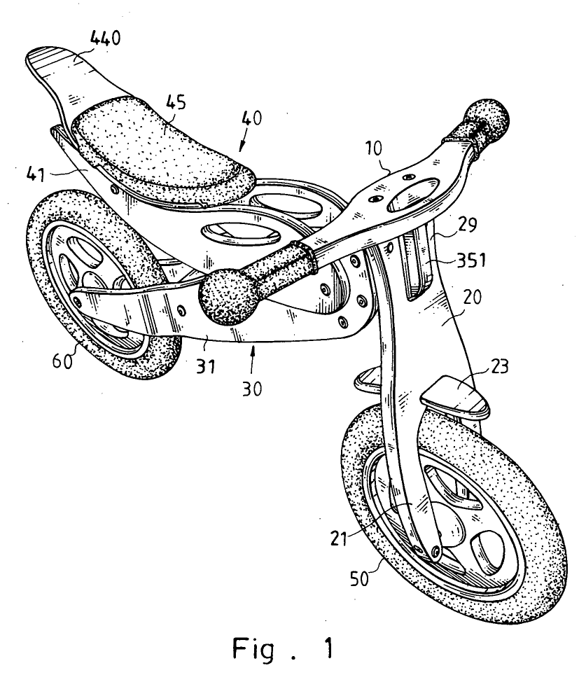

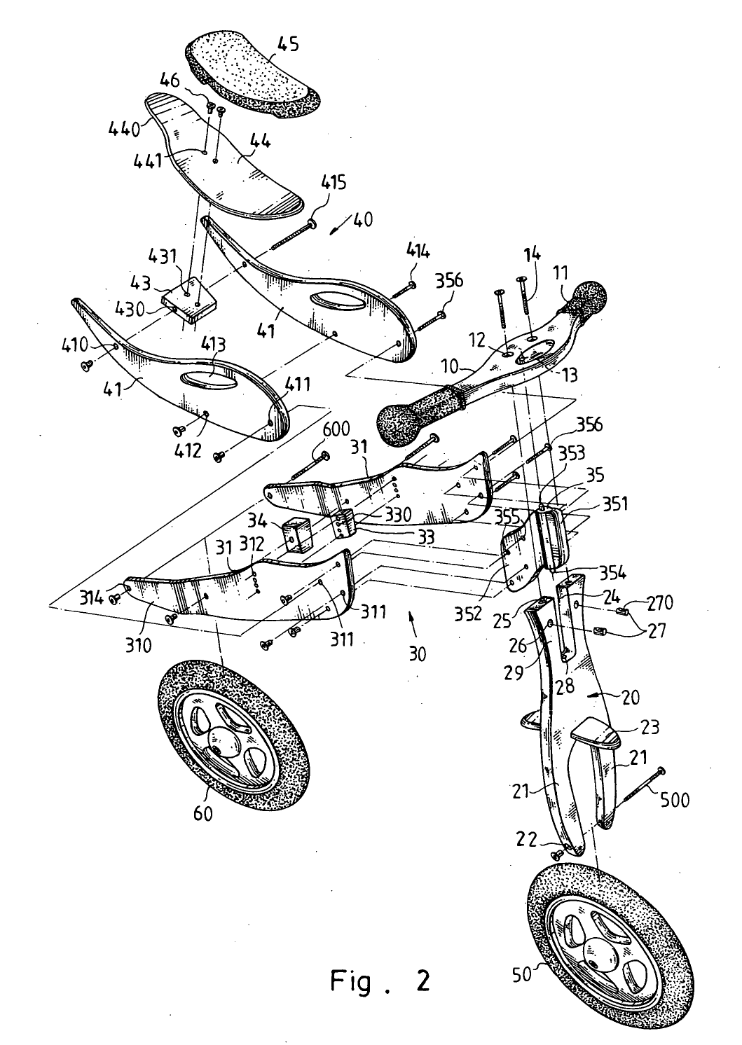

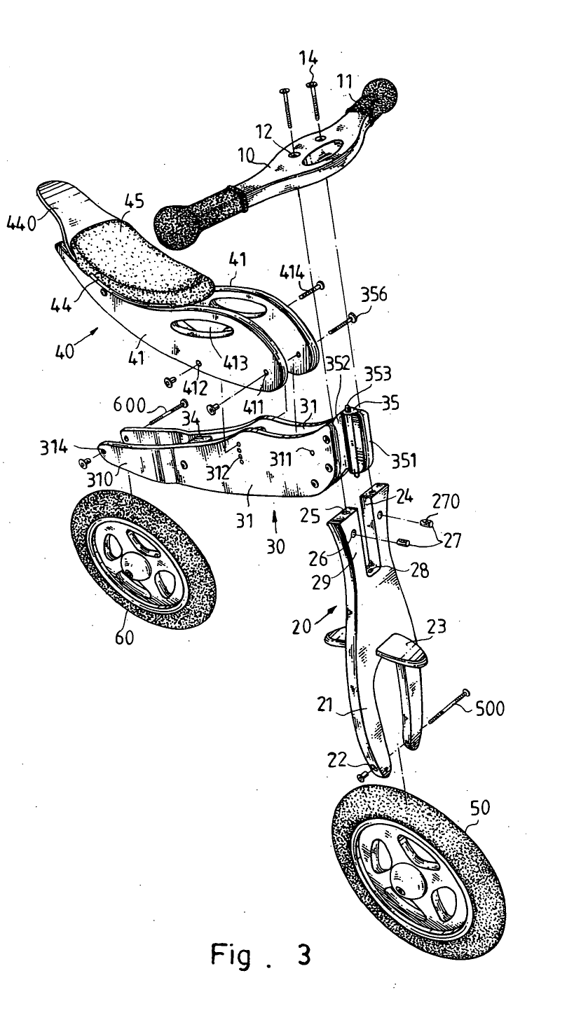

Referring to the drawings and initially to FIGS. 1-3, a walker in accordance with the preferred embodiment of the present invention comprises a front fork 20, a handlebar 10 mounted on an upper end 29 of the front fork 20, a front wheel 50 mounted on a lower end 21 of the front fork 20, a support unit 30 mounted on the upper end 29 of the front fork 20 in a downwardly inclined manner, a rear wheel 60 mounted on a lower portion of the support unit 30, and a seat unit 40 mounted on an upper portion of the support unit 30.

The front fork 20 has a mediate portion provided with a mudguard 23 located above the front wheel 50. The upper end 29 of the front fork 20 has a forked shape and has an inside formed with a receiving recess 24 having a bottom wall formed with a pivot hole 28. The upper end 29 of the front fork 20 has an end face formed with two axially extending counterbores 25 and a side face formed with two transversely extending through bores 26 for mounting two roll-shaped locking nuts 27 each having a screw bore 270 connected to the respective counterbore 25 of the front fork 20. The lower end 21 of the front fork 20 has a forked shape and has a forked end portion formed with two transversely extending shaft holes 22 to allow passage of a front shaft 500 which is extended through the front wheel 50 which is located between the shaft holes 22.

The handlebar 10 is secured to the upper end 29 of the front fork 20 by two locking bolts 14 to control the direction of the front fork 20. The handlebar 10 has a mediate portion formed with two through holes 12, and each of the locking bolts 14 is extended through the respective through hole 12 of the handlebar 10 and the respective counterbore 25 of the front fork 20 and is screwed into the screw bore 270 of the respective locking nut to secure the handlebar 10 to the upper end 29 of the front fork 20. The handlebar 10 has two ends each provided with a soft protective jacket 11 and has a bottom formed with a pivot hole 13.

The support unit 30 includes a pivot seat 35 pivotally mounted on the upper end 29 of the front fork 20, two support plates 31 each having a first end secured to the pivot seat 35 and a second end 310 mounted on the rear wheel 60 which is located between the second ends 310 of the support plates 31, a first connecting block 33 mounted between the support plates 31, and a second connecting block 34 mounted between the support plates 31.

The pivot seat 35 of the support unit 30 is pivotally mounted in the receiving recess 24 of the front fork 20 and has an upper end provided with a first pivot shaft 353 pivotally mounted in the pivot hole 13 of the handlebar 10 and a lower end provided with a second pivot shaft 354 pivotally mounted in the pivot hole 28 of the front fork 20. The pivot seat 35 of the support unit 30 has a rear side provided with a rear board 352 located between the support plates 31 and a front side provided with a front board 351 protruding outward from the receiving recess 24 of the front fork 20 to limit rotation of the pivot seat 35. The rear board 352 of the pivot seat 35 has a plurality of fixing holes 355.

Each of the support plates 31 of the support unit 30 has a mediate portion formed with a plurality of adjusting holes 312 having different heights. The first end of each of the support plates 31 has a plurality of fixing holes 311 secured to the fixing holes 355 of the pivot seat 35 by a plurality of fixing members 356. The second end 310 of each of the support plates 31 has a transversely extending shaft hole 314 to allow passage of a rear shaft 600 which is extended through the rear wheel 60.

The first connecting block 33 of the support unit 30 has a plurality of adjusting holes 330 having different heights. The first connecting block 33 and the second connecting block 34 of the support unit 30 are located between the mediate portions of the support plates 31.

The seat unit 40 is angle adjustably mounted on the upper portion of the support unit 30 and includes two seat plates 41 mounted outside of the support plates 31 of the support unit 30, a seat board 44 mounted on the seat plates 41, a seat cushion 45 mounted on the seat board 44, and a connecting piece 43 mounted between the seat plates 41.

Each of the seat plates 41 of the seat unit 40 has a first end pivotally mounted on the first end of the respective support plate 31, a mediate portion adjustably mounted on the mediate portion of the respective support plate 31 and a gradually reduced second end extending upward in an inclined manner. Each of the seat plates 41 of the seat unit 40 has an oblong grip hole 413 to facilitate a user gripping the seat plates 41. The first end of each of the seat plates 41 has a through hole 411 to allow passage of one of the fixing members 356. The mediate portion of each of the seat plates 41 has a positioning hole 412, and the seat unit 40 further includes an adjusting bolt 414 extended through the positioning hole 412 of each of the seat plates 41, either one of the adjusting holes 312 of the support plates 31 and either one of the adjusting holes 330 of the first connecting block 33 to adjust the angle and height of the seat plates 41 relative to the support plates 31. The second end of each of the seat plates 41 has a through hole 410.

The connecting piece 43 of the seat unit 40 is located above the support plates 31 of the support unit 30. The connecting piece 43 of the seat unit 40 has a side formed with a transversely extending through hole 430 secured to the through hole 410 of each of the seat plates 41 by a screw member 415. The connecting piece 43 of the seat unit 40 has a face formed with a plurality of axially extending locking holes 431.

The seat board 44 of the seat unit 40 has two sides rested on the seat plates 41. The seat board 44 of the seat unit 40 is substantially arc-shaped and has a rear portion formed with a curved portion 440. The seat board 44 of the seat unit 40 has a mediate portion formed with a plurality of through holes 441, and the seat unit 40 further includes a plurality of locking screws 46 extended through the through holes 441 of the seat board 44 and screwed into the locking holes 431 of the connecting piece 43.

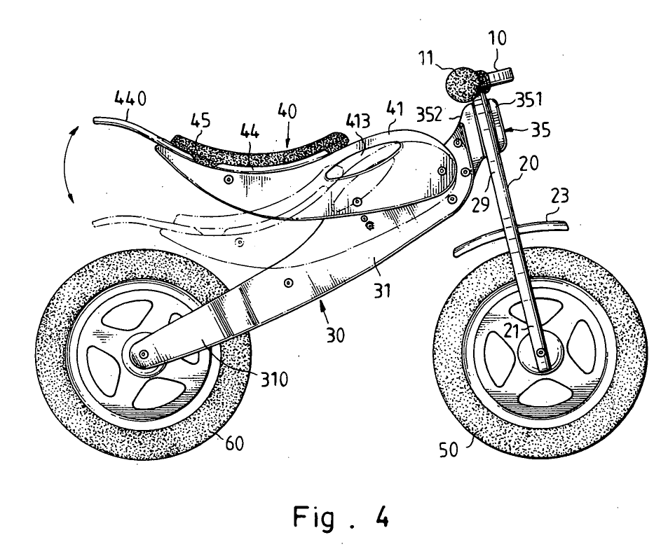

In adjustment, referring to FIGS. 1-4, the adjusting bolt 414 is extended through the positioning hole 412 of each of the seat plates 41 and positioned in either one of the adjusting holes 312 of the support plates 31 to adjust the angle and height of the seat plates 41 relative to the support plates 31 so as to adjust the angle and height of the seat unit 40 relative to the support unit 30 so that the inclined angle and height of the seat unit 40 can be adjusted to fit users of different sizes as shown in FIG. 4.

Accordingly, the walker is assembled and detached easily and rapidly to facilitate a user mounting and dismantling the walker. In addition, all of the parts of the walker are detachable before assembly to reduce the volume largely, thereby decreasing costs of packaging, storage and transportation of the walker. Further, the walker has a simplified construction, thereby greatly decreasing costs of fabrication.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A walker, comprising:
a front fork;
a handlebar mounted on an upper end of the front fork;
a front wheel mounted on a lower end of the front fork;
a support unit mounted on the upper end of the front fork in a downwardly inclined manner;
a rear wheel mounted on a lower portion of the support unit;
a seat unit mounted on an upper portion of the support unit.

2. The walker in accordance with claim 1, wherein the upper end of the front fork has a forked shape.

3. The walker in accordance with claim 1, wherein the handlebar is secured to the upper end of the front fork by two locking bolts to control the direction of the front fork.

4. The walker in accordance with claim 3, wherein the upper end of the front fork has an end face formed with two axially extending counterbores and a side face formed with two transversely extending through bores for mounting two roll-shaped locking nuts each having a screw bore connected to the respective counterbore of the front fork, the handlebar has a mediate portion formed with two through holes, and each of the locking bolts is extended through the respective through hole of the handlebar and the respective counterbore of the front fork and is screwed into the screw bore of the respective locking nut to secure the handlebar to the upper end of the front fork.

5. The walker in accordance with claim 1, wherein the lower end of the front fork has a forked shape.

6. The walker in accordance with claim 1, wherein the lower end of the front fork has a forked end portion formed with two transversely extending shaft holes to allow passage of a front shaft which is extended through the front wheel which is located between the shaft holes.

7. The walker in accordance with claim 1, wherein the support unit includes a pivot seat pivotally mounted on the upper end of the front fork, and two support plates each having a first end secured to the pivot seat and a second end mounted on the rear wheel.

8. The walker in accordance with claim 7, wherein the upper end of the front fork has an inside formed with a receiving recess having a bottom wall formed with a pivot hole, the handlebar has a bottom formed with a pivot hole, the pivot seat of the support unit is pivotally mounted in the receiving recess of the front fork and has an upper end provided with a first pivot shaft pivotally mounted in the pivot hole of the handlebar and a lower end provided with a second pivot shaft pivotally mounted in the pivot hole of the front fork.

9. The walker in accordance with claim 7, wherein the pivot seat of the support unit has a rear side provided with a rear board located between the support plates and a front side provided with a front board protruding outward from the receiving recess of the front fork to limit rotation of the pivot seat.

10. The walker in accordance with claim 9, wherein the seat unit is angle adjustably mounted on the upper portion of the support unit and includes two seat plates mounted outside of the support plates of the support unit, a seat board mounted on the seat plates, a seat cushion mounted on the seat board, and a connecting piece mounted between the seat plates.

11. The walker in accordance with claim 10, wherein each of the seat plates of the seat unit has a first end pivotally mounted on the first end of the respective support plate, a mediate portion adjustably mounted on the mediate portion of the respective support plate and a gradually reduced second end extending upward in an inclined manner.

12. The walker in accordance with claim 11, wherein the rear board of the pivot seat has a plurality of fixing holes, the first end of each of the support plates has a plurality of fixing holes secured to the fixing holes of the pivot seat by a plurality of fixing members, and the first end of each of the seat plates has a through hole to allow passage of one of the fixing members.

13. The walker in accordance with claim 11, wherein the support unit further includes a first connecting block mounted between the support plates, and a second connecting block mounted between the support plates.

14. The walker in accordance with claim 13, wherein each of the support plates of the support unit has a mediate portion formed with a plurality of adjusting holes having different heights, the first connecting block of the support unit has a plurality of adjusting holes having different heights, the mediate portion of each of the seat plates has a positioning hole, and the seat unit further includes an adjusting bolt extended through the positioning hole of each of the seat plates, either one of the adjusting holes of the support plates and either one of the adjusting holes of the first connecting block to adjust the angle and height of the seat plates relative to the support plates.

15. The walker in accordance with claim 10, wherein the second end of each of the seat plates has a through hole, the connecting piece of the seat unit has a side formed with a transversely extending through hole secured to the through hole of each of the seat plates by a screw member, the connecting piece of the seat unit has a face formed with a plurality of axially extending locking holes, the seat board of the seat unit has a mediate portion formed with a plurality of through holes, and the seat unit further includes a plurality of locking screws extended through the through holes of the seat board and screwed into the locking holes of the connecting piece.

16. The walker in accordance with claim 10, wherein each of the seat plates of the seat unit has an oblong grip hole to facilitate a user gripping the seat plates.

17. The walker in accordance with claim 10, wherein the seat board of the seat unit is substantially arc-shaped and has two sides rested on the seat plates and a rear portion formed with a curved portion.

18. The walker in accordance with claim 7, wherein the rear wheel is located between the second ends of the support plates, and the second end of each of the support plates has a transversely extending shaft hole to allow passage of a rear shaft which is extended through the rear wheel.

19. The walker in accordance with claim 10, wherein the connecting piece of the seat unit is located above the support plates of the support unit.

20. The walker in accordance with claim 14, wherein the first connecting block and the second connecting block of the support unit are located between the mediate portions of the support plates.
